(19) United States
(12) Patent Application Publication
(10) Pub. No.: US 2008/0233544 A1
(43) Pub. Date: Sep. 25, 2008

(54) Collapsible flight training hood

(76) Inventors: Mike Lorden, Issaquah, WA (US); Michael Shope, Newcastle, WA (US)

Correspondence Address: DWC LAW FIRM, P.S., P.O. BOX 3041, SEATTLE, WA, 98114-3041, US

(21) Appl. No.: 11/728,186

(22) Filed: Mar. 23, 2007

(51) Int. Cl. G09B 9/36

(52) U.S. Cl. 434/41

(57) ABSTRACT

A flight training hood that can be collapsed for compact storage. A spring member can quickly restore the flight training hood to its pre-collapsed position ready for use.

### BACKGROUND OF THE INVENTION

1. Field of the Invention

The present invention relates to collapsible hoods for use in IFR flight training.

2. Description of Related Art

In order to be Instrument Flight Rules (IFR) certified, pilots must train under IMC (Instrument Meteorological Conditions). IMC describes weather conditions that normally require pilots to fly primarily by reference to instruments.

During IFR training, IMC flight conditions are simulated. This typically includes exercises that restrict student vision to instruments. However, since peripheral vision can interfere with such training, and since human instinct will inevitably drive students to look up or outward away from a cockpit instrument panel during training, view limiting devices are commonly employed.

Common view limiting devices include IFR training hoods. Some typical hoods include a head band portion used to retain the hood on a student's head, and a large bill that extends outward above the student's eyes. A surface of the bill may be curved downward on either side to aid in further blocking side peripheral vision. Also, some hoods have drape portions that extend downward on each outer side of the hood to help block side peripheral vision.

Because such hoods need to have large surface area to be effective, they are often bulky and cumbersome to store.

### BRIEF SUMMARY OF THE INVENTION

Various embodiments of the present invention comprise a flight training hood having a bill portion that extends outward over a student's eyes, with one or more spring components and non-rigid view obstructing material, and a holding member, such as a flexible elastic headband, for retaining the flight training hood on a head of a user during flight training. The non-rigid view obstruction material can be, without limitation, nylon or fabric, and the spring component can be an elongated spring extending proximate at least a portion of a perimeter of the view obstruction material. The bill, or view obstruction member, can be easily collapsed by being twisted and folded a plurality of times to form looped overlapping portions for storage. A spring bias of the view obstruction member can quickly restore the view obstruction member to its extended position ready for use.

### BRIEF DESCRIPTION OF THE SEVERAL VIEWS OF THE DRAWING(S)

FIG. 1 is a simplified perspective view of an embodiment of a flight training hood of the present invention, showing the hood worn by a user.

FIG. 2 is a perspective view of the flight training hood of FIG. 1, removed from the user's head of FIG. 1, and showing an embodiment of a headband for the flight training hood having end portions with hook and loop fasteners.

FIG. 3 is a perspective view of the flight training hood of FIG. 2 (without showing the headband or view obstruction drapes for purposes of clarity), after having been twisted in the directions of arrows “A” and “B” of FIG. 2.

FIG. 4 is a perspective view of the flight training hood of FIG. 3, after having been twisted in the directions of arrows “C,” “D,” “E,” and “F” of FIG. 3.

FIG. 5 is a perspective view of the flight training hood of FIG. 4, after having right side loop portion 32 partially folded rearward in the direction as shown by arrows “G” of FIG. 4.

FIG. 6 is a perspective view of the flight training hood of FIG. 5, after having the right side loop portion 32 of FIG. 5 further folded rearward until it overlaps the left side loop portion 30 behind it.

FIG. 7 is a perspective view of the flight training hood of FIG. 6, with a left side of the loop portion 30 (last shown in FIG. 6) now being twisted in the directions of arrows “K” and “L” to reveal an opposite side surface of the view obstruction material and to form a second stage left side loop 34 as shown in FIG. 8.

FIG. 8 is a perspective view of the flight training hood of FIG. 7, with a second stage left side loop 34 having been formed from twisting loop 30 in FIG. 7.

FIG. 9 is a perspective view of the flight training hood of FIG. 8, as collapsed through the steps illustrated in FIGS. 2-9, and after the second stage left side loop 34 has been folded rearward in the direction or arrow “M” in FIG. 8 against the back surface of the loop 30.

FIG. 10 is a perspective view of the flight training hood of FIG. 9, also illustrating an embodiment of a non-rigid storage case for the flight training hood, in which the flight training hood can be stored to hold the hood in a collapsed position.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known structures associated with springs have not been described in detail to avoid unnecessarily obscuring the descriptions of the embodiments of the invention.

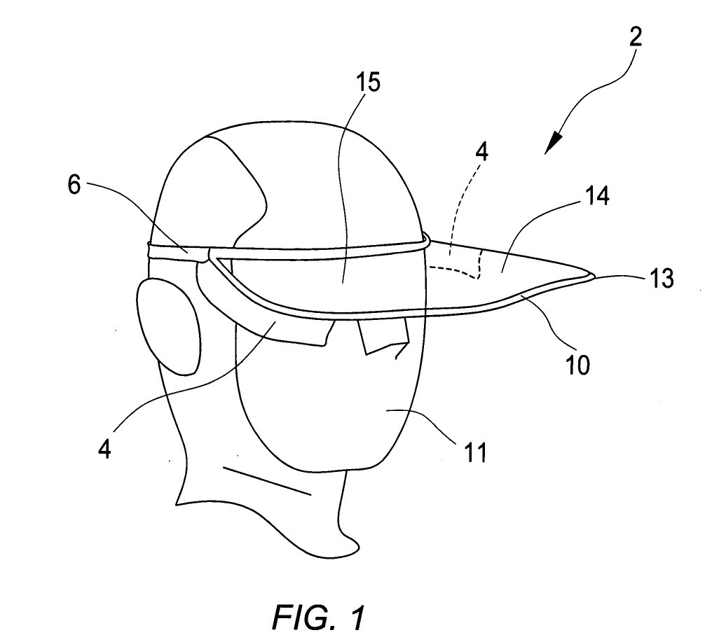

FIG. 1 shows an embodiment of the flight training hood 2 of the present invention, having drapes 4 that can hang downward from a bill 13 of the flight training hood 2. The flight training hood 2 can be worn by a user 11 as illustrated with a headband portion 6 being used to retain it on the head of the user 11 during training.

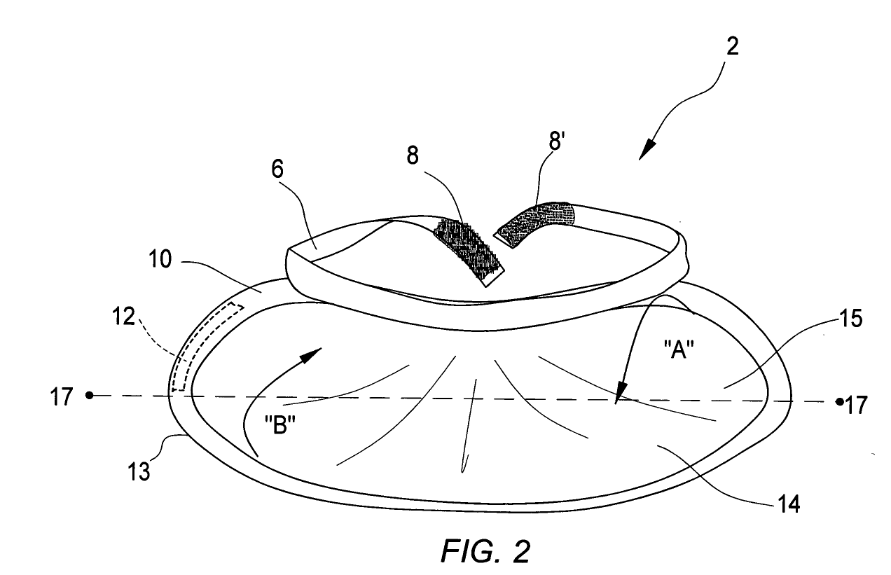

FIG. 2 shows the flight training hood 2 of FIG. 1 (without the drapes 4 being illustrated, for purposes of clarity) removed from the user. Headband portions 6 are shown with end portions 8, 8′ having respective hook and loop fastener elements for quick coupling of end portions 8, 8′. Various other manners for removably attaching the end portions 8, 8′ of the headband 6 are also contemplated for the present invention, as will be appreciated by those skilled in the art after reviewing this disclosure. In other embodiments, the headband 6 can be a continuous looped headband without end portions. Also, in some embodiments of the present invention, the headband 6 is made of elastic material that can be stretched to accommodate different users.

In FIG. 2, a bill band 10 is shown to contain an elongated spring 12, such as, for example, without limitation, an elongated flat spring strip. In various embodiments of the present invention, the spring 12 extends throughout the entire perimeter of the bill 13, within bill band 10. That is, for example, the bill band 10 can be made of nylon or reinforced fabric, and can be formed in wrap-around fashion stitched at an inner edge perimeter thereof to form an inner chamber in which the spring 12 is contained. The materials of construction described are not intended to be limiting.

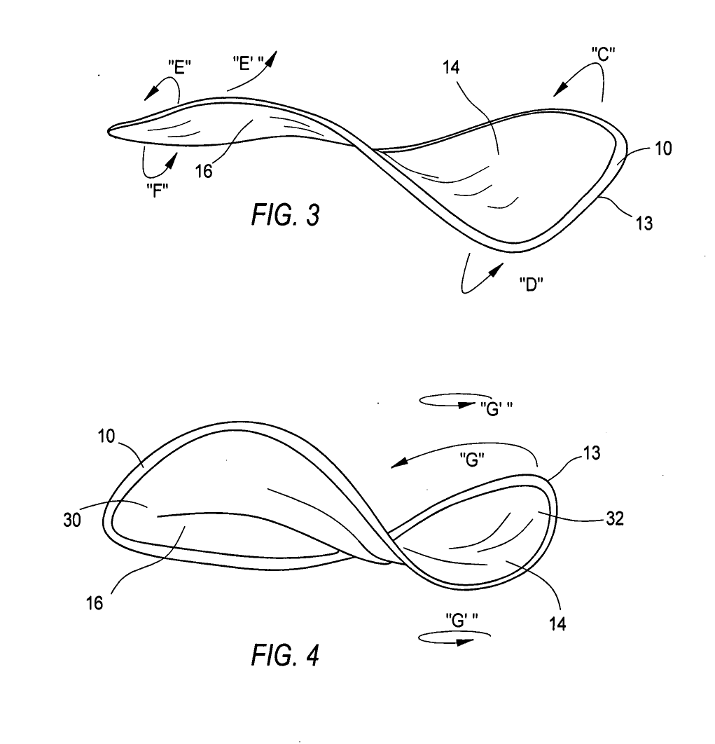

Also, a non-rigid view obstructing surface 15 can extend, or stretch, between the inner perimeter portions of the bill band 10, and the view obstructing material 15 can have upper surface 14, and a lower surface 16 (seen in FIGS. 3-10). The view obstructing surface can also be, for example, nylon or fabric.

In the following description of steps for collapsing an embodiment of the flight training hood 2 of the present invention, it will be understood by those skilled in the art after reviewing this disclosure that the steps described are not meant to be limiting or necessarily carried out in the particular order described.

Referring to FIG. 3, the bill 13 of the flight training hood 2 is shown (i.e., the flight training hood 2 is shown without showing the headband 6 or the drapes 4, for purposes of clarity) in a position after having been partially twisted about a longitudinal axis 17 of the bill 13, in the directions of arrows “A” and “B” of FIG. 2.

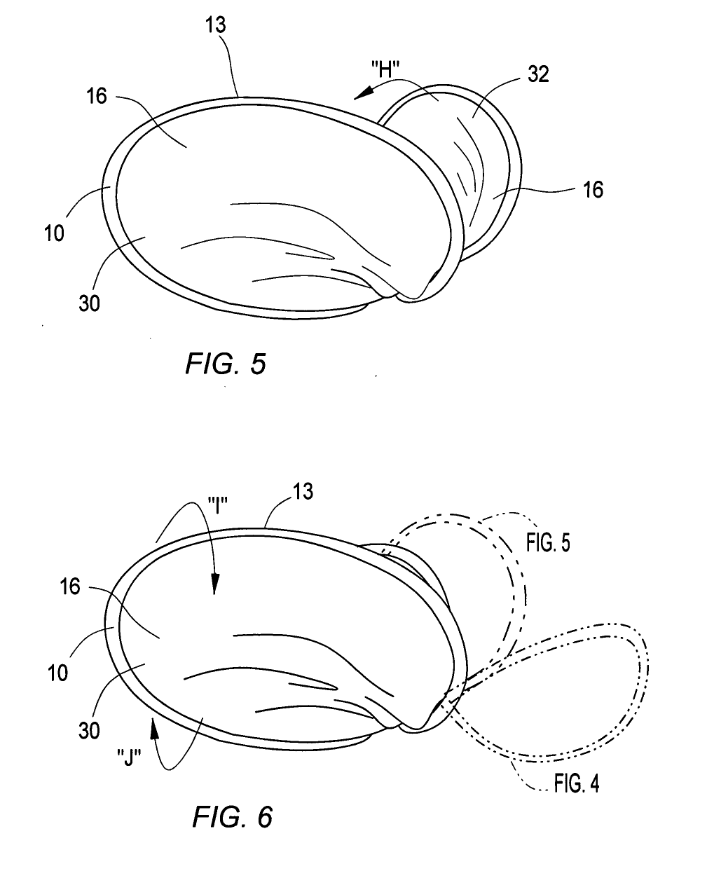

FIG. 4 shows a position of the bill 13 after having been further twisted in the directions of the arrows in FIG. 3. In particular, arrows “C” and “D” on a right side of the flight training hood 2, and arrows “E” and “F” on a left side of the flight training hood 2, represent simultaneous twisting motions that can be applied by hand to the flight training hood 2 to place it in the position shown in FIG. 4. In FIG. 4, two loop portions are now visible from the twisting applied, namely, left loop portion 30 and right loop portion 32, with each loop portion 30, 32 being defined by the bill band 10 (or spring 12 inside the bill band 10). Also, as viewed in FIG. 4, the left side portion has been twisted upward to expose the lower side surface 16 of the view obstruction material 15, rather than the upper side surface 14 previously shown in FIG. 2.

Arrows “G′” of FIG. 4, show a folding direction in which the right side loop portion 32 can be folded to bring the right side loop portion 32 behind the left side loop portion 30.

FIG. 5 shows right side loop portion 32 partially folded rearward and FIG. 6 shows the bill 13 of the flight training hood 2 after the right side loop portion 32 of FIG. 5 is further folded rearward until it overlaps the left side loop portion 30 behind it.

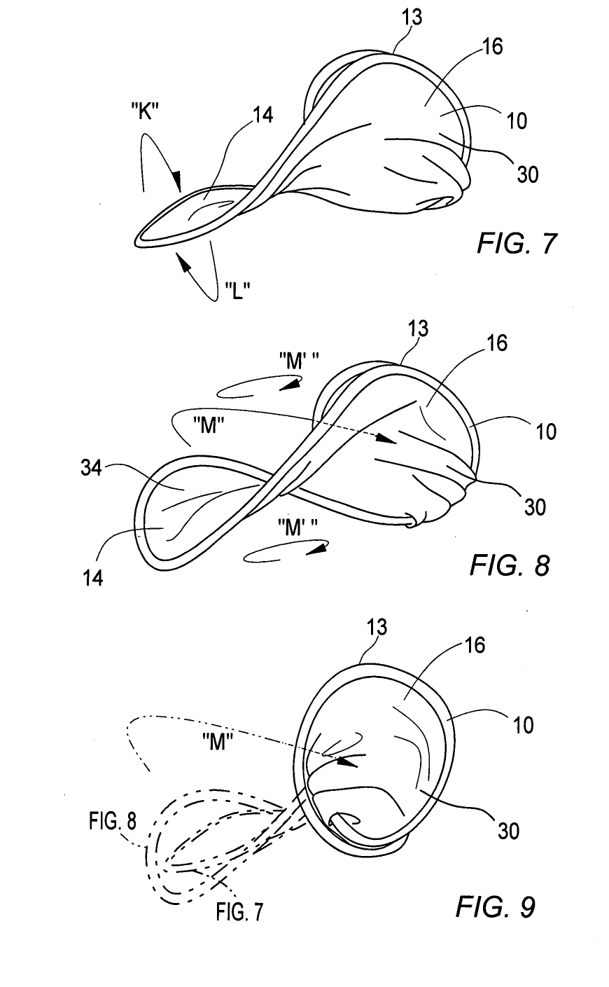

Now referring to FIG. 6, a left side portion of the loop 30 (the left side loop 30 in FIG. 5) can be twisted in the direction of arrows “I” and “J,” and then further in the directions of arrows “K” and “L” in FIG. 7, until upper surface 14 of the view obstruction material 15 is again visible as shown in FIGS. 7 & 8, and until another left loop 34 is formed in the loop 30 (loop 30 was formerly referred to as the left side loop 30 above), as shown in FIG. 8.

As shown FIG. 8, the left loop 34 can now be folded rearward in the direction of arrow “M′” until the left loop 34 overlaps the loop 30 in FIG. 9, behind it (Arrow “M” shows a path of a point on the left loop as it is folded rearward in manner generally represented by arrows “M?). At this stage in FIG. 9, the front surface area represented by the perimeter of the bill 13 facing outward from the illustration can be, in some embodiments, about one third or less in area than the front surface area represented by the upper surface 14 of the view obstruction material 15 in FIG. 2. In this manner, the flight training hood 2 can be collapsed for compact storage.

Also, as will understood by those skilled in the art after reviewing this disclosure, when a user releases user applied tension against the flight training hood 2 during collapsing thereof, or after it is in the collapsed position of FIG. 9, the flight training hood 2 can automatically and quickly return to its extended position, or original shape, as shown in FIGS. 1 & 2. This can be driven by a bias of the spring 12. Furthermore, it is noted that drapes 4 and headband 6 have no rigidity in various embodiments of the present invention, and can thus be easily collapsed with the bill 13 of the flight training hood 2 to form the compact structure for storage in FIG. 9.

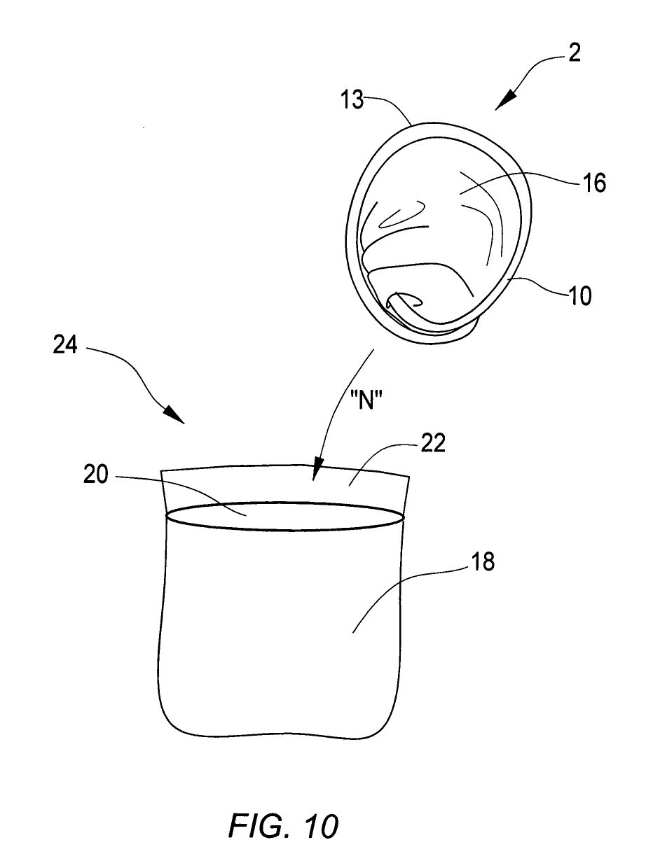

In some embodiments of the present invention, a storage case 24 is provided for retaining the flight training hood 2 in a collapsed position, such as the collapsed position shown in FIGS. 9 & 10. The storage case 24 can itself be made of non-rigid material, such as, for example, without limitation, nylon or fabric. In the illustrated embodiment in FIG. 10, the storage case 24 is made of stitched nylon and has a pocket configuration with opening 20, and cover flap 22. The collapsed flight training hood 2 can be placed in the body 18 of the storage case 24 and cover flap 22 can be folded over to close the opening 20. In some embodiments of the present invention, the cover flap 22 can be secured against the case to hold it closed, using any of a variety of different securing devices, such as, for example, a hook and loop fastener, a button, or a latch (not illustrated in the drawings). In yet further embodiments of the present invention, the flight training hood 2 can be provided with integral securing devices for holding the flight training hood 2 in the collapsed position during storage. Examples of integral securing devices (not illustrated in the drawings) include separate hook and fastener devices, buttons or latch mechanisms. In some embodiments of the present invention, the end portions 8, 8′ of the headband 6 itself, can be wrapped about the collapsed flight training hood 2 and connected together in a fashion to secure the hood in a collapsed position, as will be understood by those skilled in the art after reviewing this disclosure.

Although specific embodiments and examples of the invention have been described for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A flight training hood comprising:
a holding member for holding the flight training hood to a head of a user; and
a view obstruction member having a non-rigid view obstruction surface and an elongated spring extending proximate at least a portion of a perimeter of the view obstruction surface, wherein the view obstruction member can be collapsed from an extended position for use in flight training to a collapsed position for storage.

2. The flight training hood of claim 1 wherein when the view obstruction member is collapsed, the bias of the spring can be allowed to return the view obstruction member to the extended position for use in flight training.

3. The flight training hood of claim 2 wherein when the view obstruction member is collapsed, the elongated spring is positioned in a plurality of loops.

4. The flight training hood of claim 1 wherein collapsing the view obstruction member includes twisting the view obstruction member to form a plurality of overlapping looped portions of the view obstruction member, with the looped portions being defined by a configuration of the elongated spring.

5. The flight training hood of claim 4 further comprising a storage case for holding the collapsed view obstruction member in a collapsed position against the bias of the elongated spring.

6. The flight training hood of claim 1 wherein collapsing the view obstruction member for storage includes twisting the view obstruction member.

7. The flight training hood of claim 6 wherein collapsing the view obstruction member for storage further includes folding the view obstruction member so that portions of the view obstruction surface overlap.

8. A collapsible flight training hood comprising:
a headband; and
a collapsible view obstructing member capable of being placed in an extended position having an extended front surface area, and with the extended position having sufficient self sustainable rigidity to allow the view obstructing member to be used for limiting a line of sight of a flight student during instrument flight training, and wherein the view obstructing member can be collapsed to reach a collapsed position with a collapsed front surface area, the collapsed front surface area being about one third or less in total area than the extended front surface area.

9. The collapsible flight training hood of claim 8 wherein collapsing the view obstructing member includes twisting the view obstructing member.

10. The collapsible flight training hood of claim 8 wherein when the view obstructing member is collapsed, it can be collapsed into a plurality of loops.

11. The collapsible flight training hood of claim 8 wherein after the view obstructing member is collapsed, it can automatically return to the extended configuration under the bias provided by a spring.

12. The collapsible flight training hood of claim 8 wherein the self rigidity of the view obstructing member is provided by a spring.

13. The collapsible flight training hood of claim 8 further comprising an elongated spring that extends about at least a portion of a perimeter of the view obstructing member within a band defining a perimeter of the view obstructing member.

14. A method of flight training comprising:
wearing a collapsible hood during flight training to limit a field of vision;
collapsing the hood against a spring bias of the hood to store the hood prior to further use; and
allowing the hood to be returned to an extended position by permitting the spring bias to automatically return the hood to the extended position for use.

15. The method of claim 14 wherein collapsing the hood comprises twisting the hood.

16. The method of claim 14 wherein collapsing the hood comprises folding the hood.

17. The method of claim 14 wherein collapsing the hood comprises twisting and folding the hood to form a plurality of looped portions.

18. The method of claim 17 further comprising placing the hood in a storage case to retain the collapsed configuration of the hood.

19. The method of claim 14 further comprising allowing a view obstruction drape to hang downward from a bill of the hood when it is in an extended position.

20. The method of claim 14 further comprising retaining the hood in the collapsed position using a fastener attached to the hood.
